(19) United States
(12) Patent Application Publication
(10) Pub. No.: US 2002/0037149 A1
(43) Pub. Date: Mar. 28, 2002

(54) Fiber optic scanner

(76) Inventor: Shiping Chen, Rockville, MD (US)

Correspondence Address: Charles D. Holland, Morrison & Foerster LLP, 755 Page Mill Road, Palo Alto, CA, 94304-1018, US

(21) Appl. No.: 09/805,676

(22) Filed: Mar. 13, 2001

Related U.S. Application Data
(60) Provisional application No. 60/188,873, filed on Mar. 13, 2000.

(51) Int. Cl. G02B 6/00

(52) U.S. Cl. 385/147

(57) ABSTRACT

The disclosed scanning structure includes an apparatus for light delivery and light receiving from a light-excitable area on a substrate to be measured by the scanning structure. The light delivery and receiving apparatus may include an optical fiber having a proximal end and a distal end which transmits light having a certain wavelength or light with several varying wavelengths to excite the substrate samples. This optical fiber may also simultaneously receive light which may be emitted by fluorescing samples on the substrate. The scanning structure also may further include a holder for the optical fiber that is able to transverse variable distances over the substrate to be measured or examined. Holders may include galvano scanners as well as resonating suspension beams. A light source, e.g., a laser, may be optically coupled to the optic fiber's proximal end. And this light source may be of a certain wavelength, but multiple light sources each having a different wavelength may also be used simultaneously by coupling the light sources into either a single optic fiber through wavelength multiplexers or by placing individual optic fibers carrying differing wavelengths in close proximity to each other. As the light is transmitted down to the substrate through the optic fiber, the fiber is sufficiently close to the substrate microarray so that it can also receive the emitted fluorescing light.

### CROSS-REFERENCE TO RELATED APPLICATIONS

This application claims the benefit of U.S. provisional app. No. 60/188,873 filed Mar. 13, 2000. This application is also related to the PCT application entitled “Fiber Optic Scanner”, inventor Shiping Chen, reference 473532000340, filed on even date herewith, both of which are incorporated by reference in their entirety herein.

### TECHNICAL FIELD

The invention relates to equipment and methods for scanning microarrays or microwells in a microplate, such as DNA microarrays, protein microarrays, and compound microarrays.

### BACKGROUND

A microarray is an array of spots of biological or chemical samples (“probes”) mobilized at predefined positions on a substrate. Each spot contains a number of molecules of a single biological material or chemical. The microarray is flooded with a fluid containing one or more biological or chemical samples (the “target”), which typically interact with one or more complimentary probes on the microarray. In DNA microarrays in particular, the probes are oligonucleotide or cDNA strains, and the target is a fluorescent or radioactive-labeled DNA sample. The molecular stands in the target hybridize with complimentary strands in the probe microarray.

The hybridized microarray is inspected by a microarray reader, which detects the presence of the radioactive label or which stimulates the fluorescent label to emit light by exciting the label using a laser or other energy source. The reader detects the position and strength of the label emission in the microarray. Since the probes are placed in predetermined and thus known positions in the microarray, target sequences in the fluid are identified by the position at which fluorescence or radiation is detected and the strength of the fluorescence or radiation.

A microarray reader is therefore one of the key pieces of equipment in microarray technology. Currently, there are two types of microarray readers available. The first type, an example of which is depicted in U.S. Pat. No. 5,324,633, is based on scanning microscope principles, where laser beams at two or more wavelengths are combined and focused on a single spot on the microarray to excite the fluorescent labels. The combined laser beam scans across the entire microarray point-by-point at a high spatial resolution (˜10 μm) by either carrying the microarray on a two-axis translation stage, or moving the microscope lens in one axis and the microarray substrate on the other. The second type, an example of which is illustrated in WO00/12759, uses a CCD imager to detect the fluorescent emission from the microarray one small region at a time. A broadband light source, such as an arc lamp, is used to excite fluorescence.

For scanning microscope technology, the cost driver is its optical system, as it has to combine and precisely align multiple laser beams at different wavelengths and later re-split them into separate detection channels. Both the microscope lens and the slide carrier are bulky and heavy and cannot be moved very fast, which limits scanning speed.

In the CCD based system, the imager and lens are both the main cost drivers. Here, the excitation light is expanded to a large area causing a great reduction in energy density. The exposure time has to be extended several tens of seconds to compensate for this reduction. Because of the long exposure time, the CCD imager has to be cooled to maintain a reasonable single to noise ratio. Such a cooled, large format CCD imager is very expensive at present. In addition, the optical lens in the system has to be corrected for chromatic aberrations and image distortions over a large field of view, which significantly increases its cost in comparison to the lens in the point-to-point system in a scanning microscope. Furthermore, there is currently no CCD imager with sufficient resolution and format to cover the entire area of a slide (25 mm×75 mm). Mechanical scanning is still required for CCD based systems, which reduces the speed of the reader. At present, most microarray readers on the market require 5 minutes or more to complete the scanning of a 25 mm×70 mm slide, which is too slow for many applications.

Optical fibers have been used in near field scanner microscopy (D. W. Pohl, “Scanning near-field optical microscopy” in Advances in Optical and Electron Microscopy 12, C. J. R. Sheppard and T. Mulvey, Eds. (Academic Press, London, 1990); M. H. P. Moers, W. H. J. Kalle, A. G. T. Ruiter, J. C. A., G. Wiegant, A. K. Raap, J. Greve, B. G. De Grooth, N. F. van Hulst, J. Microscopy 182,p. 40, (1996)), where light energy is guided to a fiber tip reduced to sub-micron in diameter. The fiber tip is brought to within several tens of nanometer of the surface to be inspected. Then, the tip scans over a small area (normally within 10 mm square) and collects the direct scattering light from the inspected surface. (Chuck, In the disclosed invention, the fiber core is much larger to maximize the light collection and the collected light is indirect emission, such as fluorescence from the object under inspection.)

On the other hand, optical fiber reader head has been use to collect fluorescent emission from microtiter plates in a number of instruments such as ABI's Taqman reader [U.S. Pat. No. 5,589,351]. Here the spatial resolution of the reader is in the order of several millimeters.The excitation and receiving lights travel through different fibers in a bundle. The optical head is kept at a relative large distance from the object.

### SUMMARY

The invention provides a number of systems, components, means, and methods for scanning probe microarrays or samples (dry or liquid, as contained in microwells) as are more fully described below. This section of the disclosure provides a summary of some salient points of the invention, but this section is not to be interpreted as limiting the scope of the invention to only those features and embodiments discussed in this section. Instead, the invention involves all components, systems, and methods discussed in this and the following sections as well as the appended claims.

The disclosed scanning structure includes an apparatus for light delivery and light receiving from a light-excitable area on a substrate to be measured by the scanning structure. The light delivery and receiving apparatus may be comprised of an optical fiber having a proximal end and a distal end which transmits light having a certain wavelength or light with several varying wavelengths to illuminate the samples and excite light emission or have one or more of the wavelengths absorbed by the samples. This optical fiber may also simultaneously receive light which may be emitted by fluorescing samples on the substrate or light that has otherwise encountered the samples and been reflected or diffracted. The scanning structure also may further include a holder for the optical fiber that is able to traverse variable distances over the examined substrate. Examples of holders may include galvano scanners as well as resonating suspension beams. To generate the light which excites the substrate samples, a light source, e.g., a laser, may be optically coupled to the optic fiber's proximal end. Multiple light sources each having a different wavelength may be used simultaneously by coupling the light sources into either a single optic fiber through wavelength multiplexers or by placing individual optic fibers carrying differing wavelengths in close proximity to each other. As the light is transmitted down to the substrate through the optic fiber, the fiber is sufficiently close to the substrate microarray so that it can also receive the emitted fluorescing light.

Although certain embodiments of the invention are described as causing fluorescence, the invention also includes other forms of light generation such as chemilluminescence and light absorption so that an absorption spectrum is generated and transmitted by the light conducting portion (e.g. fiber or rod) of the scanning structure. Thus, a light excitable area on a substrate is a portion of the subsrate containing a wet or dry sample that either generates light of a different wavelength than the light received by the substrate (such as by fluorescence or chemilluminescence) or an area that absorbs one wavelength of multiple wavelengths transmitted to the substrate by the light conduction portion of the scanning structure. Therefore, a second wavelength that is “generated” by the light excitable area on the substrate may be a wavelength that is not provided by the light source or may be a wavelength that the light source transmits and is reflected or diffracted by the sample or substrate but the substrate or sample in the light-excitable area does not absorb. Thus, a scanning structure can be configured to detect light or to detect the absence of a wavelength of light.

As the spatial resolution of the scanner equals approximately the diameter of the fiber core that transmits the excitation light energy, the preferred core diameter is therefore 5 μm, 10 μm for scanner with 5 μm or 10 μm spatial resolutions, respectively. Such core diameters are readily available in communication fibers. There is no need to reduce the core size at the fiber tip.

Aside from microarrays on tranditional square or rectangular substrates, the disclosed scanner can be adapted to read a rotating substrate in the manner of a CD and one dimensional microarrays.

In addition to microarrays, the disclosed invention can further be adapted to read arrays of microscopic reaction wells in high throughput screening applications.

At present, the output signals of HTS, which could be fluorescence, chemiluminescence or absorbance are detected using a device referred as “microplate readers”. This invention relates to a scanner that reads such signals from solutions in microwell arrays with size and density comparable to today's DNA microarrays (e.g., more than about 500 wells/cm², preferably more than about 1,000 wells/cm², more preferably more than about 2,000 wells/cm², and even more preferably more than about 5,000 wells/cm²). The inner diameter of the microwell is from about 100 microns to about 1,000 microns, preferably no more than about 500 microns, and more preferably no more than about 200 microns. In a specific embodiment, the optical fiber scanner of this invention is adapted as a reader of signals from solutions in microwells. For instance, the angle that the optical fiber makes with the substrate may be vertical or near vertical to avoid reflection but also detect the presence or absence of light. The diameter of the fiber may be selected based on the diameter of the microwells. The length of time that the reader waits before scanning may be selected based on the reaction or association time needed for the sample and probe (oligonucleotide, protein, or reactant, for instance) to associate or react with the sample. The optical fibers provide the flexibility that enables the reader to be integrated into the screening system.

### BRIEF DESCRIPTION OF THE DRAWINGS

FIGS. 1(a) and 1(b) depict embodiments of the present invention used in scanning probe microarrays.

FIG. 2 illustrates that an optical fiber excites an area very close to its core region in the distal end facet, and light from a portion of the illuminated area may be collected by the same fiber.

FIG. 3 depicts an embodiment combining magnetic and aerodynamic levitation for read head support.

FIG. 4 depicts an embodiment for generating a thin gas cushion for read head support.

FIG. 5 depicts a double-core optical fiber having varying refractive indexes.

FIG. 6 depicts a scanner embodiment for combining multiple different wavelengths into a single optical path.

FIG. 7 depicts a scanner embodiment for bundling or closely configuring separate fibers having light of differing wavelengths.

FIG. 8 depicts a side view and a top view of a scanner embodiment utilizing a galvano scanner.

FIG. 9 depicts a side view and a top view of a scanner embodiment utilizing a resonating suspension beam.

FIGS. 10(a), 10(b), and 10(c) depict the progression and measurement of a translation stage relative to a stationary stage using beacons of varying strength.

FIG. 11 depicts multiple varying probes disposed upon a one dimensional microarray utilizing the translation stage of FIGS. 10(a), 10(b), and 10(c).

FIG. 12 depicts a scanner embodiment having a rotating substrate.

### DETAILED DESCRIPTION OF THE INVENTION

In this invention, many basic optical elements for the delivery of excitation light and possibly also for the collection of the fluorescent emission may be used. Such optical elements may include devices such as light-guiding rods and optical fibers. It may be preferable to use optical fiber as the optical element and the embodiments disclosed in the following discuss the use of such optical fibers as examples; however, the invention is not so limited.

One embodiment of the invention, a scanning structure (10), is illustrated in FIG. 1(a) where an excitation laser light (20) emitted from laser (14) is reflected by filter (16) before excitation laser light (20) is coupled into a proximal end (28) of optical fiber (12), which guides excitation light (20) to illuminate the sample, e.g., DNA probes, on microarray sample (30) through distal end (26) of optical fiber (12). Microarray sample (30) may be comprised of substrate (32) and probes (34), as discussed above. Filter (16) may be selectively designed to reflect a pre-selected wavelength or range of light while simultaneously allowing the passing of a desired wavelength or range of reflected light. The fluorescent light (20′) emitted from probes (34) may be collected by the same fiber (12) and is guided to detector (18) after passing through filter (16). The excitation light (20) and fluorescent light (20′) in embodiment (10) are separated by filter (16), which reflects light at a specific wavelength while allowing a particular wavelength to pass through. In the particular embodiment depicted in FIG. 1(a), filter (16) may be designed to reflect excitation light (20). The system can also be adapted to use a filter that reflects the fluorescent light by swapping the positions of laser (14) and detector (18) in FIG. 1(a).

FIG. 1(b) depicts an alternative embodiment (22) of the same system design where the bulk optic beam splitting and coupling structure is replaced by a fiber optic coupler (24). Structures in different embodiments depicted with the same numbering are used to indicate similar function throughout this description. Coupler (24) can also be a wavelength domain multiplexer (WDM) which selectively couples a particular wavelength to the other fiber branch. An additional filter (16) may preferably be placed in front of detector (18) to reject the excitation light.

Yet another embodiment utilizes light emitting diodes (LEDs) as a source of excitation light (20) rather than a laser. A single LED or multiple LEDs each emitting light at a different wavelength may be disposed directly adjacent substrate (32) yet still allow optical fiber (12) to gather fluorescent light (20′) or replace laser (14) at the optical fiber proximal end (28).

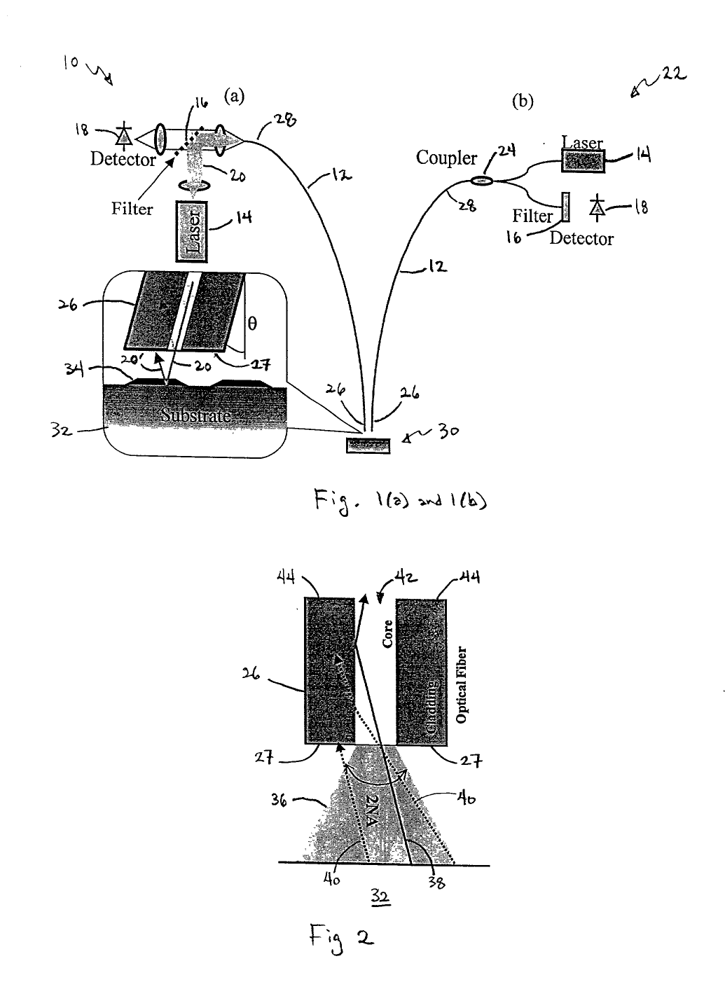

As depicted in FIG. 2, light (36) exiting optical fiber distal end (26) will diverge at a characteristic angle defined by the numerical aperture (NA) of the fiber. In order for a light beam to be guided by the fiber, the light beam should satisfy both of the following conditions: 1) the light beam enters the fiber within the core region, defined by the numerical aperture of the fiber; and 2) the light beam intersects the fiber axis at an angle smaller than NA. For example, light beam (38), as represented by an arrow, can be guided into core region (42) because it satisfies both of the above conditions. However, light beams (40) are not guided and enter cladding (44) rather than core region (42) because they only satisfy one of the above conditions.

Because of the beam divergence and guiding conditions, the light emitted in the region very close to the core of the fiber is collected in the embodiments illustrated in FIGS. 1(a) and (b). The light collection power of the fiber is determined by two factors: 1) the core size; and 2) the NA. The larger these two parameters, the higher the light collection power of fiber (12). However, a large core size may reduce the spatial resolution of the system. The spatial resolution is approximately equal to the size of the fiber core when the distance between fiber tip (12) and substrate (32) is within d_{c}/2NA, where d_{c} is the diameter of fiber core (42). If substrate (32) is greater than distance, d_{c}/2NA, away from fiber tip (12), the efficiency of fluorescent light collection may be significantly reduced. Standard telecommunication fibers have a core diameter of about 9 μm and NA=0.12. Therefore, if a standard telecommunication fiber is used to form a scanning structure of this invention, a spatial resolution of approximately 10 μm can be achieved if the substrate surface is kept within about 38 μm from fiber facet (27). Fibers with NAs as large as 0.66 have been reported. The potential exists to boost light collecting power by about 27 times by having fiber facet (27) kept to within about 7 μm of the substrate.

Several measures may be adopted to provide a fiber (12) in close proximity to substrate (32).

A first embodiment of a scanning structure of this invention detects the distance between fiber tip (12) and substrate (32) surface in real time and actively controls this gap. The size of the gap may be detected by conventional methods such as optical interometry using interferometers, and the gap is controlled by attaching the fiber to e.g. a piezoelectric actuator (such as the one described in U.S. Pat. No. 6,142,444) that moves in response to signals received from the interferometers.

A second scanning structure of the invention is configured to allow the tip of fiber (12) to aerodynamically “float” across microarray substrate (32) on a cushion of air created by rapid movement of the fiber tip near the substrate. This is a technology used in floppy disk drives, hard drives, and CD-ROM drives, for instance. The read head of a floppy disk drive is suspended by an air gap a couple of micrometers thick, which is created aerodynamically through a so-called “ground effect” created by the air between the rotating floppy disk and the read head. The relative movement of the read head and floppy disk creates a vacuum that draws the read head to the floppy disk surface, but as the read head nears the surface, sufficient pressure builds within the gap between the read head and the disk surface that the read head does not contact the disk surface.

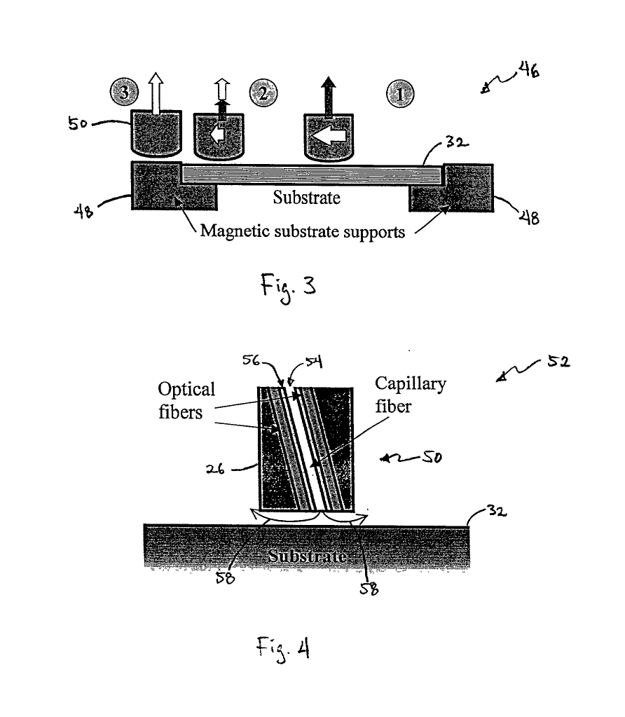

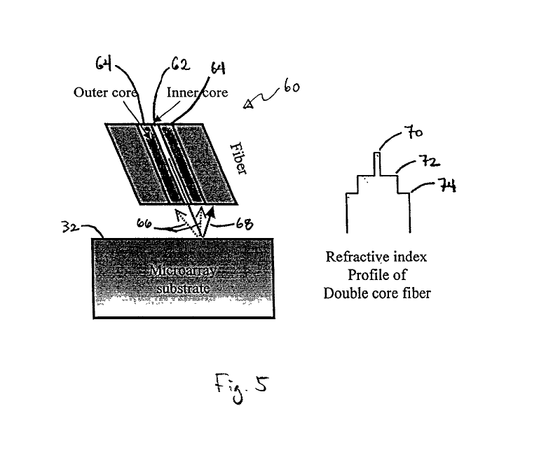

This “ground effect” may be applied to a scanner of this invention. The fiber tip moves sufficiently rapidly across the surface of the substrate that the relative movement between the fiber and substrate draws the fiber tip to within a few microns of the surface of the substrate. As illustrated in FIG. 3, the fiber tip may be housed in a read head (50) having a shape that, together with substrate (32), forms a venturi through which the air flows to create the ground effect. A read head may be one optical fiber attached to a holder that moves the fiber across the surface of the substrate, or a read head may be a bundle of optical fibers attached to a holder as discussed in further detail below. The surface of the read head that faces the substrate surface may have a parabolic shape in profile as illustrated in FIG. 3, or the read head may have a flat face as illustrated in FIG. 1 or FIG. 2. If the velocity is less than the velocity needed to create the ground effect, the read head or fiber tip may contact the substrate or a portion of a substrate holder as the read head or fiber tip slows to reverse direction and scan the microarray while traveling in the opposite direction.

A scanning structure (46) having a combined magnetic and aerodynamic levitation can prevent the read head or fiber tip from contacting the substrate or substrate holder as the read head or fiber tip slows to reverse direction during scanning. As illustrated in FIG. 3, microarray substrate (32) of scanning structure (46) is supported on a pair of magnets (48) each having a similar polarity direction. The read head (50) with integrated optical fibers may be formed with integrated permanent magnets or may itself be magnetized (when formed of a magnetic material) so that its polarity is similar to the pair of support magnets (48) to provide a repulsive force between the read head and magnets (48). At the middle of substrate (32) at Position 1 where read head (50) moves relatively fast, read head (50) floats aerodynamically. As read head (50) moves toward the edge of substrate (32) from Position 2 to Position 3, read head (50) slows. This slowing reduces the aerodynamic float, but the read head (50) is supported by the magnetic force from magnetic supports (48) to maintain a read head (50) suspension that prevents the read head from contacting the microarray substrate (32) or magnets (48).

A third embodiment of a scanning structure of the invention is particularly well-suited to activate and detect labels of a microarray on a substrate having a rough surface, although its use is not limited to a microarray on a substrate having a rough surface. In scanning structure (52) illustrated in FIG. 4, a fiber capillary (54) may be incorporated among optical fibers (56) to maintain a consistent aerodynamic float for read head (50). If multiple fibers are used, they may be bundled together randomly, or they may be placed in a linear or ordered array with known spacings to allow faster or redundant microarray scanning. A very thin gas cushion (58) may be generated between read head (50) and substrate (32) by blowing a gas down through capillary fiber (54). Any inert gas may be used such as air or nitrogen. Because fiber-based read head (50) is very light, a small amount of positive pressure should be sufficient to float read head (50) over substrate (32) and maintain a small distance on the order of a few microns between them. The amount of positive pressure will depend on the specific design of read head (50).

A number of features such as signal-to-noise ratio improvement, multiple wavelength excitation and collection, and scanning mechanisms are discussed in the following sections.

Signal-to-Noise Ratio Improvement

If an axis along the length of fiber (12) is substantially perpendicular to the surface of substrate (32), a certain amount of the original excitation light (20) will be reflected off a facet (27) of fiber (12) to the substrate (32) and then back to fiber (12), thereby producing background noise in the signal. This background noise may be suppressed by filter (16) in the system, as depicted in FIG. 1(a) and 1(b). Filter (16) acts to suppress the background noise by reflecting light of unwanted wavelengths that the detector (18) would otherwise detect. However, because of the relative weakness of the emitted fluorescent light, there may still be a significant level of noise despite the filter suppression. One scanning structure having a greater signal to noise ratio (SNR) includes a fiber (12) which is tilted relative to the surface of substrate (32) by an angle, θ, which angle is slightly larger than the NA of fiber (12), as depicted in FIGS. 1 and 5. This configuration allows the reflected excitation light to pass through the wall of the fiber instead of being guided to the detector by the optical fiber.

An alternative embodiment of a scanning structure with greater SNR includes a fiber (12) in which its facet (27) is polished so that it is substantially parallel to the surface of substrate (32). This polishing causes any light (including excitation light(20)) directly reflected off a fiber facet (27) and microarray substrate (32) to intersect the fiber (12) axis at an angle larger than the NA thus preventing this light from being guided to the detector (18) via fiber core (42). On the other hand, fluorescent light (20′) is emitted in all directions and the same proportion of light (20′) as is captured by a fiber with unpolished facet will be captured by fiber (12) leaving its signal level unaffected. As a result, the SNR in the system can be improved significantly.

Another scanning structure having enhanced SNR employs a double-core fiber (60) which, as depicted in FIG. 5, has two concentric cores (62, 64), with the refractive index of core (62) being greater than the refractive index of core (64). A relative refractive index profile of double-core fiber (60) is seen in FIG. 5 where peak (70) corresponds to the relative refractive index of inner core (62), peak (72) corresponds to the index of outer core (64), and peak (74) corresponds to the index of the cladding of fiber (60).

A scanning structure having a double-core fiber (60) has a near 100% coupling ratio to light received from the substrate in its outer core (64) while light from the laser travels to the substrate through the inner core (62), and thus the double-core fiber acts as a core-selective coupler.

Outer core (64) acts like cladding to inner core (62) because outer core (64) has a lower refractive index than inner core (62). Consequently, when a double-core fiber is used in the system depicted in FIG. 1(b), excitation light (20) from e.g. a laser is launched into inner core (62) at an angle less than the critical angle, and the excitation light is essentially confined to inner core (62).

The light in outer core (64) will be coupled out by this double-core fiber. Light entering outer core (64) at an angle greater than the critical angle for inner core (62) does not undergo internal reflection in inner core (62) and is therefore found primarily in outer core (64), leaving essentially only light from the laser in inner core (62).

Moreover, inner core (62) may have a small NA so that dispersion of the light beam (68) after exiting inner core (62) is small. Most of the fluorescent emissions (66), on the other hand, are collected by outer core (64) and travel back up fiber (60) to the detector. In this way, the light collection efficiency can be increased significantly, which in turn boosts the SNR. In addition, because the outer core (64) can be made much larger in diameter than inner core (62), the intensity of the collected light is less critically dependent upon the distance between the facet (27) of fiber (12) and substrate (32), providing more tolerance and freedom in the instrument design.

One method for fabricating double-core fiber (60) involves chemical vapor deposition (CVD). This involves depositing a first concentration of a dopant, e.g., Ge in gaseous form with silane and O₂, on the inner surface of a conventional fiber-forming tube (preform) to form a layer. Then, a second concentration of dopant (consisting either of the same dopant as the first concentration or a similar typical dopant) greater than the first concentration may be doped upon the layer, followed by stretching the preform to form fiber (60).

Multiple Wavelength Excitation and Collection

A scanning structure of the invention typically carries at least two separate wavelengths of light, the excitation light having one wavelength and the fluorescent light emitted by the fluorescent markers having another wavelength. Scanners having up to five separate excitation and/or collection wavelengths are currently known in the art. In current microarray scanners, all light beams at different wavelengths are combined into a single optical path through an objective lens of a microscope. The bulk optical components used in a conventional scanner require precision alignment and complicated structural configurations to carry and move a number of the bulk optical components. The high precision and bulk optical components make current scanners bulky and expensive. Further, it is often difficult to separate one wavelength from another in existing optical detectors having a combined optical path. The SNR suffers when more than one laser is activated simultaneously. Many existing microarray scanners avoid this problem by switching on one laser at a time but at the cost of a much slower scanning speed.

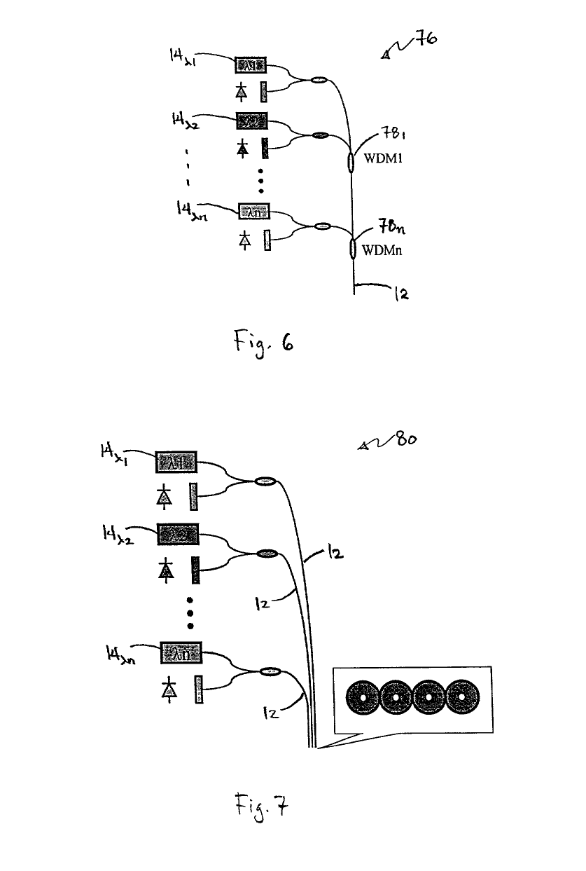

FIG. 6 depicts a scanning structure (76) of the invention in which multiple light sources (14_{λ1} to 14_{λn}) having multiple corresponding wavelengths are combined into a single optic fiber (12) through the use of Wavelength Division Multiplexers (WDM) (78₁, 78ₙ). The scanning structure is simple, especially since the flexibility of optical fiber (12) eliminates the need for complex supporting structures for e.g. lens and mirror assemblies as are currently used in existing scanners. WDMs (78₁, 78₁) are formed using techniques well-known in the telecommunications industry to form planar or fused fiber couplers, for instance.

In one embodiment of the invention, multiple wavelength light beams may be scanned simultaneously across microarray substrate (32), but the light beams need not be in exactly the same location. FIG. 7 depicts an alternative embodiment (80) which isolates one wavelength from another more easily without paying a speed penalty. As depicted in FIG. 7, optic fibers (12) may be arranged in a number of desired configurations depending upon the application to allow for each wavelength light (14_{λ1} to 14_{λn}) to scan in synchronization while illuminating a separate yet relatively closely-spaced location. Bundled optic fibers may be formed with or without the use of, e.g., a guide plate into which the fibers are inserted and then bundled to preserve their order. All articles, patents, and patent applications mentioned herein are incorporated by reference in their entirety. Because optical fibers (12) are extremely light-weight and have a very small, precise diameter, synchronized multi-spot scanning can be achieved by using separate fibers for each wavelength. Here, the individual fibers (12) may be bundled in a microarray to form a fiber optic scanning head. Such a microarray may be bundled in an ordered array or in a random bundle. The number of fibers in a bundle may be any number, but in many instances the number will be less than ten. Either variation is feasible since the relative positions of the distal ends of each fiber (12) will be known in the system. Despite the close proximity of the fiber ends, all of the fibers (12) need not be focused to illuminate the same spot, although this may be done. Rather, each of the fibers (12) may be arranged so that they illuminate and optionally also gather fluorescent light from multiple spots simultaneously.

Scanning Mechanism

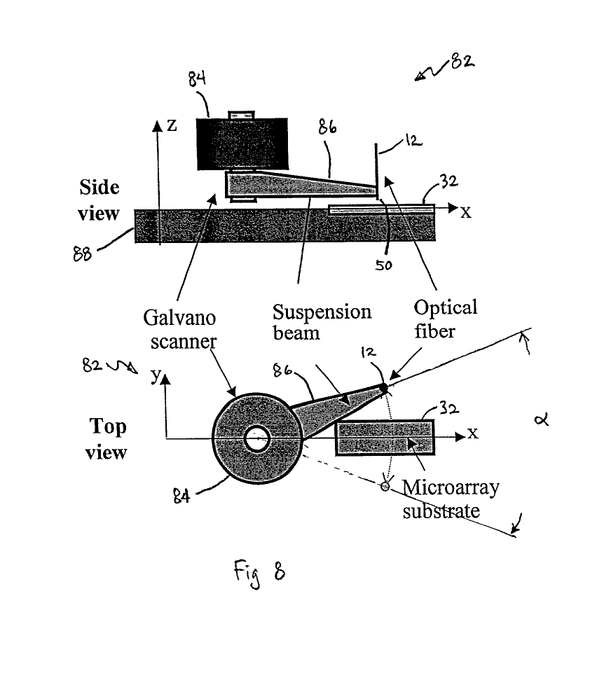

Because optical fibers (12) are very light, scanning head (50) described above can be moved very quickly, thereby increasing the microarray read speed. FIG. 8 depicts an embodiment of a scanning apparatus (82) where read head (50) of optical fiber (12) is moved back and forth in the Y-direction by a conventional galvano scanner (84). Galvano scanner (84) may be set to move suspension beam (86), which holds optic fiber (12) and read head (50), through a desired angle, α, and at a desired frequency depending upon the geometric configuration of substrate (32). The scanning apparatus can have an X-stage positioner, which moves the substrate beneath the read head and also provides information to determine where along the X axis the optic fiber (12) is reading. The optical fiber (12) position in the Y direction is determined by an angular encoder incorporated in the galvano scanner (84). As galvano scanner (84) moves suspension beam (86) in the Y direction, substrate (32) may be step-moved in the X-direction by a conventional translation stage (88).

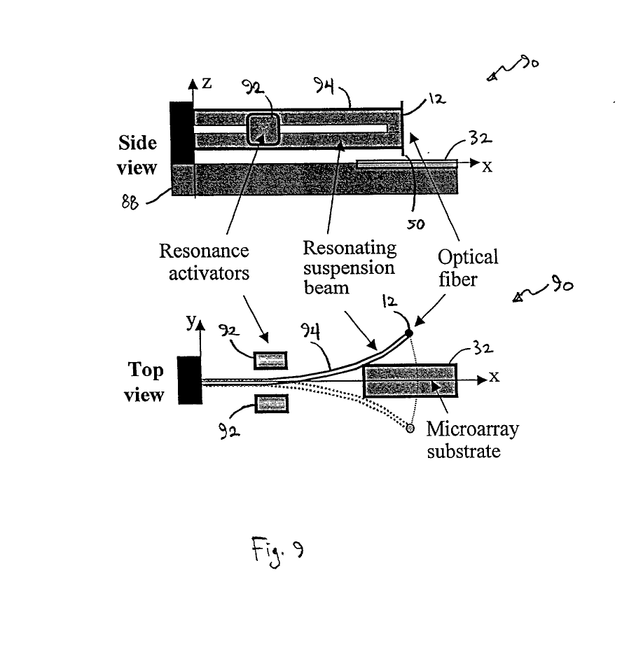

FIG. 9 depicts an alternative embodiment of a scanning apparatus (90) where galvano scanner (84) and suspension beam (86) are replaced by resonance activators (92) and resonating suspension beam (94). Here, optical fiber read head (50) is oscillated back-and-forth in the Y-direction as resonating suspension beam (94) is forced to its resonant frequency by resonance activators (92). Resonance may be actuated by any number of conventional resonance activator (92) devices such as a piezo device adjacent to resonating suspension beam (94) or by a magnetic device on each side of resonating suspension beam (94). In either embodiment, read head (50) may be set to stop at the edge or outside substrate (32), where there is no probe. Preventing contact (and thereby preventing contamination) between read head (50) and substrate (32) may be avoided by any number of conventional or previously-mentioned methods such as by the implementation of the aerodynamic suspension mechanism used to float read head (50) over substrate (32).

With the particular embodiments depicted in FIGS. 8 and 9, scanning head (50) travels in a curved path in the Y-direction. This implies that image pixels in the row data will not be in a square grid as in most image files. However, as long as the precise position of each pixel is registered, the image file generated with this scanner can be converted into a standard image file by conventional software. The X-position in either embodiment may be registered by a conventional position encoder on translation stage (88). For the embodiment depicted in FIG. 8, the Y-position may be calculated from the angular position generated by galvano scanner (84) as it sweeps through angle, α. For the embodiment depicted in FIG. 9, the Y-position may be calculated by any one of several different methods. One method involves measuring and recording the strain at known locations on the surfaces of each side of resonating suspension beam (94) by the use of conventional strain gauges. A second method involves a new optically based position measurement device, described further below, which may be adapted for such measurement purposes. A third method involves measuring the resonant period in real-time and then calculating the position of read head (50) between the two extremes of the oscillation through time.

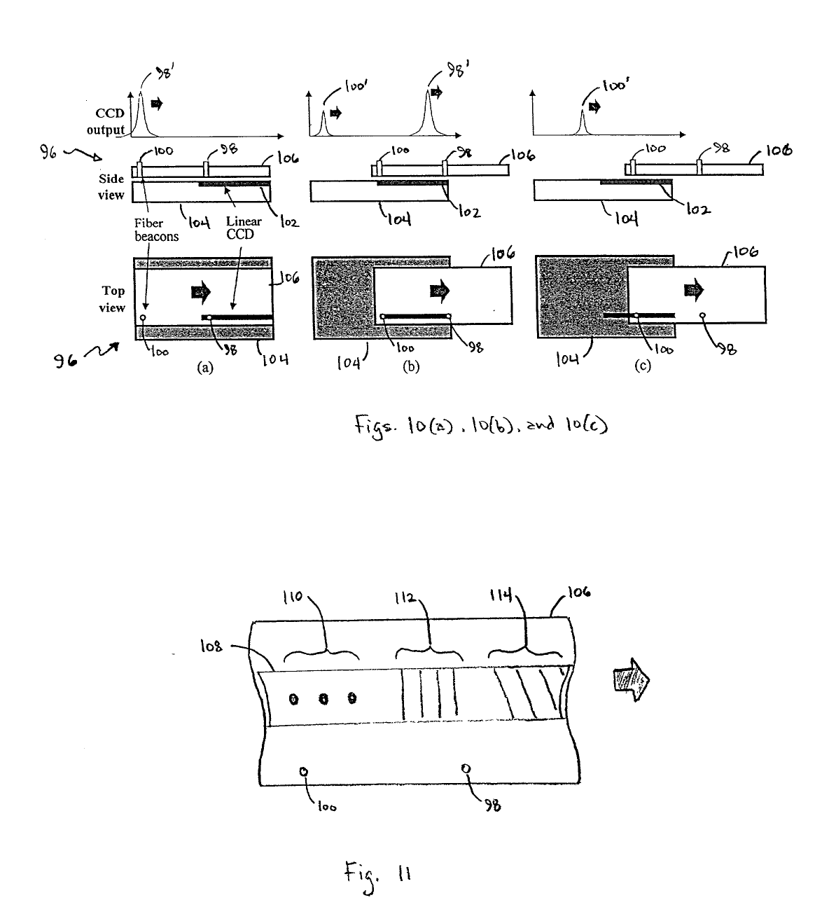

FIGS. 10(a) to 10(c) illustrate an alternative embodiment for a simpler position sensing device (96) incorporating a CCD array and fiber optic beacons. This embodiment may be feasible despite variations in slide size and translational velocities.

As illustrated in FIG. 10(a) to 10(c), optical fibers (98, 100) are installed on the moving part of translation stage (106) as beacons while stationary stage (104) remains stationary relative to translation stage (106). Alternatively, stage (106) may be held stationary while stage (104) moves. First beacon (98) is the brightest, second beacon (100) is dinner, and so on. Linear CCD array (102) may also be installed on the stationary (104), or moving (106), part of the stage. The separation between two adjacent beacons (98, 100) is slightly smaller than the length of linear CCD array (102). At the start of the translation, linear CCD array (102) will detect a single bright spot at the one end of its pixel array. The position of this spot indicates the relative position of translation stage (106), as depicted in FIG. 10(a). As this spot moves to the other end of linear CCD (102) during the translation of stage (106) and before first beacon (98) is out of the range of linear CCD (102), second beacon (100) has moved in to continue the position monitoring, as depicted successively in FIGS. 10(b) and 10(c). Any number of beacons may be used if necessary so that the position of translation stage (106) throughout the entire range can be monitored in an absolute manner.

As an example of beacon separation distances relative to a CCD length, the precise position of the spot along the pixel array can be calculated to at least about 1/50 of pixel pitch using a centroid algorithm. Considering, e.g., a typical low cost CCD array (102) with a conventional 2048 pixels and a 24 μm pitch, the effective length of linear CCD array (102) is approximately 49 mm. By installing two fiber beacons at, e.g., about 40 mm of separation, position sensing device (96) may be capable of monitoring translation stage (106) position over about a 80 mm range at a resolution of about 0.48 μm, which is more than sufficient for a microarray scanner.

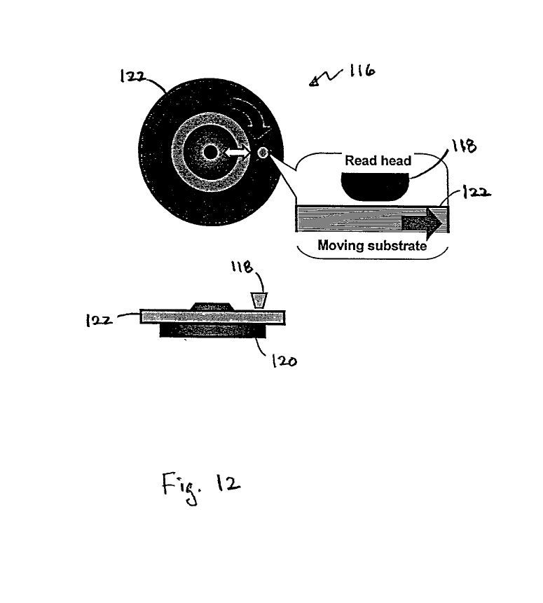

Position sensing device (96) may be utilized for an embodiment of a one dimensional microarray (108), as depicted in FIG. 11. Here, a one dimensional microarray (108) as described in copending U.S. Patent Application Ser. No. 60/244,418 entitled “Gene Thread,” inventors Shiping Chen, Yuling Luo, and Anthony Chen, and filed on Oct. 30, 2000, which is herein incorporated by reference in its entirety, may be positioned on translation stage (106). Disposed upon one dimensional microarray (108) may be standard probes (110) containing samples for hybridization. Probes may alternatively be placed in varying configurations depending upon the desired applications. Some examples may include placing probes in a linear manner (112) or diagonally (114). In any case, the position of the probes may be monitored and read using any of the methods and apparatus as described above.

An embodiment of the scanning apparatus of the invention may alternatively allow scanning by having a read head (50) which is held stationary while one dimensional microarray (108) moves below read head (50). This would eliminate the need for an oscillating read head since only the one dimensional probes (110) are moving on stage (106) in a single direction.

The setup for position sensing device (96) may also incorporate a system which identifies beacons (98, 100) through their relative peak intensities. As seen in FIGS. 10(a) to 10(c), the CCD array outputs relative signal strengths as a function of position along the array. A given signal strength corresponds to a given beacon. For instance, first beacon (98) is the brightest beacon and thus corresponds to the brightest signal (98′) and second beacon (100), which is dimmer than first beacon (98), corresponds to the dimmer signal (100′) on the CCD output, and so on. Therefore, outputs from a CCD array may be utilized in tracking beacons by their relative intensities. Alternatively, different beacons may also be identified through the spot size or the number of fibers in the beacon. For example, the first beacon (98) may comprise a single fiber forming a single spot on the CCD. The second beacon (100) may comprise two closely positioned optical fibers forming two adjacent spots, and so on. Note that the two fibers in second beacon (100) may separate from each other by a very small distance relative to the distance between first and second beacons (98, 100); e.g., first and second adjacent beacons (98, 100) may be separated by 40 mm while the two fibers in second beacon (100) may be separated from each other by a small distance such as 0.1 mm.

In addition, where the required scanning range in the X-direction is less than, approximately 30 mm, a single beacon with a CCD array or an analog position sensing device may be used. The analog position sensing device may be, for instance, a continuous photoresistor strip having differential voltage output at its two terminals proportional to the position of a light spot on the strip.

FIG. 12 illustrates an embodiment of a scanning apparatus having a rotating position sensing mechanism (116), where the microarray is fabricated on rotating substrate (122) that has a shape similar to a CD-ROM disk as described in the aforementioned copending U.S. Patent Application Ser. No. 60/244,418. In this embodiment, microarray substrate (122) may be rotated continuously by rotating stage (120) while optical read head (118) or multiple heads moves step-wise in a radial direction to scan across the entire microarray surface (122). An advantage of this design is that it allows full benefit of the mature CD-ROM design and manufacturing capability to reduce the system cost. Because the substrate may be rotated continuously at high speed, the reading speed can be accomplished faster than by conventional scanning mechanisms. This embodiment of the scanning apparatus may incorporate optical or magnetic markers in the substrate (122), as described above, which provide an indication of the position of the read head.

A scanning apparatus may incorporate read heads based on bulk optical lenses similar to what is found in a compact disk (CD) reader in addition to a read head (118) having a fiber optic as described above. This configuration may take full advantage of the existing mature technology in CD-ROM drives.

When microarray scanners are adapted as readers in high throughput screening, the microarray substrate in the system is replaced by an array of micro reaction wells, which are filled with fluids. All types of microarray scanners maybe adapted for this application. In particular, when the disclosed invention is used for this application, the optical fiber guides excitation light energy to wells and collects emission light at the same time. The well array may moves in one direction while the read head moves in the other, usually orthogonal direction to complete scanning action. On the other hand, the read head may provide the scanning motion in both directions while the array is kept stationary. Because the read head is fiber optic in the disclosed invention, it can be moved independent of the light source. This provides added flexibility to enable a compact, economical structure design.

In any of the embodiments of the invention, the scanning structure may be configured to receive light from a dry area or a wet area on a substrate. In one preferred embodiment of the invention, the area has a diameter between about 10 micron and about 500 micron. In another preferred embodiment, the area is a microwell having a diameter between about 100 and about 1000 micron. The areas are described as having a diameter because typically the areas are spots as are formed by known spotting techniques or liquid contained in wells having a circular cross section, although the areas are not confined to circular shapes.

A scanning structure can be configured to receive light of a second wavelength from an area of a specified size a number of ways. For example, the fiber or rod will have a diameter suitable to read light from the area (that is, the diameter is not so large that it overlaps two or more areas at all times the fiber or rod is reading a signal from a given area). The detector may be timed by known techniques to read signals at given times and/or given locations that correspond to the light conductive portion of the scanning structure intersecting the area to be read. The scanning speed may be altered to accommodate array density. Any combination of these techniques may also be used.

The substrate areas that react to light may be dry or wet. Microarrays of genes or proteins may be read using the scanner, as can microwells containing products of reaction or association (such as those encountered in high-throughput screeening of drugs). Such microarrays include those described in WO99/55460, WO99/55461, EP 0 955 084, WO00/53736, WO00/53739, U.S. application Ser. No. 09/758,873, filed Jan. 10, 2001, 09/791,998, filed Feb. 22, 2001, 09/791,410, filed Feb. 22, 2001, and 09/791,411, filed Feb. 22, 2001 (the latter four of which are inventions of the present applicant), all of which are incorporated by reference herein in their entirety.

A scanning structure of the invention may be used in conjunction with a substrate configured for high throughput screening as described above. The scanning structure has a light source and a detector. The substrate receives light from the light source, and a detector receives light from the substrate to detect the presence or absence of one or more wavelengths of light. Other scanners as are used to determine hybridization on a microarray containing oligonucleotides may be used in this manner as well. Such microarrays are discussed in the Background section above. These microarrays may contain at least 100, 400, or 1000 microwells per square centimeter for liquid sample processing, for instance.

Although the invention has been described with reference to particular embodiments, the description is only an example of the invention's application and should not be taken as a limitation. Various adaptations and combinations of features of the embodiments disclosed are now readily apparent to those of ordinary skill and are within the scope of the invention. All references discussed or referred to herein are incorporated by reference in their entirety as if fully put forth herein.

What is claimed is:

1. A scanning structure for delivering light to and receiving light emitted from a light-excitable area on a substrate, said scanning structure comprising an optical fiber that transmits light of a first wavelength and light of a second wavelength and having a proximal end and a distal end, which optical fiber is configured to receive at least a portion of the light of the second wavelength that is generated when said light-excitable area receives the light of the first wavelength.

2. A scanning structure according to claim 1 and further comprising additional optical fibers that transmit the light of the first wavelength and the light of the second wavelength, each of said additional optical fibers having proximal ends and distal ends and being configured to traverse the light-excitable area of the substrate in sufficient proximity to the substrate that said optical fibers capture at least a portion of the light of the second wavelength that is generated when said light-excitable area receives the light of the first wavelength.

3. A scanning structure according to claim 2 wherein the distal end of said optical fiber and the distal ends of said additional optical fibers are held in a fixed relationship.

4. A scanning structure according to claim 1 further comprising a detector optically coupled to said proximal end of said optical fiber to receive the light of the second wavelength.

5. A scanning structure according to claim 1 further comprising a holder for the substrate that is configured to move the substrate as said optical fiber scans the substrate.

6. A scanning structure according to claim 1 further comprising a holder for said optical fiber that moves between a first position and a second position, the distance between said first position and said second position being sufficient that said optical fiber traverses the light-excitable area of the substrate.

7. A scanning structure according to claim 1 and further comprising a light source that emits light of said first wavelength to excite the light-excitable area, which light source is optically coupled to the proximal end of the optical fiber so that the light of the first wavelength exits the distal end of the optical fiber.

8. A scanning structure for delivering light to and receiving light emitted from a light-excitable area on a substrate, said scanning structure comprising
a) an optical fiber having a proximal end and a distal end that transmits light of a first wavelength and light of a second wavelength;
b) a holder for the optical fiber that moves between a first position and a second position, the distance between said first position and said second position being sufficient that the optical fiber traverses the light-excitable area of the substrate, which light-excitable area emits light of the second wavelength when said light-excitable area receives light of the first wavelength,
c) a light source that emits light of said first wavelength to excite the light-excitable area, which light source is optically coupled to the proximal end of the optical fiber so that the light of the first wavelength exits the distal end of the optical fiber,
d) wherein the optical fiber is attached to the holder so that the optical fiber is sufficiently close to the microarray that the optical fiber receives said light of the second wavelength produced by the light-excitable area at the distal end of the optical fiber and transmits the light of the second wavelength to the proximal end of the optical fiber, and
e) wherein the holder is configured to be moved between the first position and the second position when the light source emits the light having the first wavelength.

9. A scanning structure according to claim 8, wherein the scanning structure further comprises a beam having a distal portion and a proximal portion, said distal portion comprises said holder, the beam is attached to a mount at the proximal end of the beam, and the beam is configured so that the distal portion of the beam moves between the first position and the second position.

10. A scanning structure according to claim 9, wherein the beam is a movable arm of a galvanometer.

11. A scanning structure according to claim 9, wherein the beam moves between the first position and the second position at a resonant frequency of the beam.

12. A scanning structure according to claim 11, wherein the resonant frequency of the beam is actuated piezoelectrically.

13. A scanning structure according to claim 11, wherein the resonant frequency of the beam is actuated magnetically.

14. A scanning structure according to claim 9, wherein the proximal end of the beam is attached to the mount such that the proximal end of the beam is not movable.

15. A scanning structure according to claim 8 wherein the holder is configured to move horizontally between the first position and the second position, and wherein the scanning structure further comprises a magnet configured to repel the holder in a vertical direction when the holder reaches at least one of said first position and said second position.

16. A scanning structure according to claim 8, wherein the light source comprises a laser which emits the light at the first wavelength.

17. A scanning structure according to claim 8, wherein the scanning structure further comprises an optical filter comprising a first branch channel and a second branch channel, which optical filter is configured to receive the light of the first wavelength from the laser in the first branch channel and which optical filter is configured to transmit the light of the second wavelength from the light-excitable area through the second branch channel.

18. A scanning structure according to claim 8, wherein the scanning structure further comprises a substrate translation stage that moves the substrate along a direction generally perpendicular to a line defined by the first position and the second position.

19. A scanning structure according to claim 8, wherein the holder secures the optical fiber at an angle other than perpendicular to the substrate.

20. A scanning structure according to claim 8, wherein a surface defining the distal end of the optical fiber is substantially parallel with the substrate.

21. A scanning structure according to claim 1, wherein the optical fiber further comprises a capillary fiber.

22. A scanning structure according to claim 1, wherein the optical fiber is a double core fiber comprising an inner core having a first refractive index and an outer core exterior to the inner core and having a second refractive index, said first refractive index being greater than the second refractive index.
